(19) United States
(12) Patent Application Publication
(10) Pub. No.: US 2003/0147663 A1
(43) Pub. Date: Aug. 7, 2003

(54) Fixing apparatus and image forming apparatus

(75) Inventor: Yasuyuki Fukutome, Tokyo (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/061,198

(22) Filed: Feb. 4, 2002

(51) Int. Cl. G03G 15/20

(52) U.S. Cl. 399/69

(57) ABSTRACT

A fixing apparatus includes a fixing device which has a first roller and a second roller which is pressed against the first roller, and fixes a developer image on a transfer medium by passing the transfer medium on which the developer image has been transferred between the first and second rollers, first and second heat sources which are respectively provided in the first and second rollers and generate heat in order to heat the first and second rollers when energized, a detection device which detects the temperature of the first roller, and a control device which controls energization of the first and second heat sources based on the result of detection by the detection device in such a manner that the first roller reaches a predetermined temperature.

### BACKGROUND OF THE INVENTION

The present invention relates to a fixing apparatus which fixes a toner image on a recording medium by fusion and pressure welding in, e.g., a color electronic copier, a printer, a facsimile machine or the like and to an image forming apparatus.

As one kind of color electronic copier, there is one having a photoreceptor belt which supports a latent image, a plurality of developing units which supply toners of respective colors (Y, M, C, K) being arranged so as to be opposed to the photoreceptor belt. This color electronic copier is configured to form a color image by superposing and transferring toner images of respective colors formed on the photoreceptor belt onto an intermediate transfer medium and then collectively transfer this color image onto a sheet of recording paper. Subsequently, the recording paper onto which the color image has been transferred is supplied to a fixing apparatus, and the color image is fixed to the recording paper by this fixing apparatus.

There are some fixing apparatuses which are provided with a fixing roller and a pressure roller which is pressed against this fixing roller. A heater is provided in each of the fixing roller and the pressure roller. In this fixing apparatus, the paper on which a toner image has been transferred is caused to pass to the inside of a nip portion formed between the fixing roller and the pressure roller. Such a roller fixing method has been conventionally widely used.

Meanwhile, the temperature of the fixing roller and that of the pressure roller are detected by a sensor (thermistor), and energization of respective heaters in the fixing roller and the pressure roller is controlled to be turned on and off based on temperatures detected by the sensor (thermistor). That is, when the fixing roller reaches 170° C. and the pressure roller reaches 120° C. for example, energization of the heaters is stopped.

In the prior art, however, when the temperature of the pressure roller reaches 120° C., energization of the heater in the pressure roller is stopped even if the fixing roller has yet to reach 170° C. Thus, the heat of the fixing roller is taken by the pressure roller, and it takes time for the fixing roller to reach a set temperature (170° C.). As a result, the warming-up time becomes long.

### BRIEF SUMMARY OF THE INVENTION

In view of the above-described problem, it is an object of the present invention to provide a fixing apparatus and an image forming apparatus which can efficiently heat a first roller (or an endless belt) without heat of the first roller (or the endless belt) being taken by a second roller.

According to a first aspect of the present invention, there is provided a fixing apparatus comprising: a fixing device which has a first roller and a second roller which is pressed against the first roller and fixes a developer image on a transfer medium by passing the transfer medium on which the developer image has been transferred between the first and second rollers; first and second heat sources, which are provided in the first and second rollers, that generate heat when energized and heat the first and second rollers; a detection device which detect a temperature of the first roller; and a control device which controls energization of the first and second heat sources based on a result of detection by the detection device in such a manner that the first roller reaches a predetermined temperature.

According to a second embodiment of the present invention, there is provided a fixing apparatus comprising: a fixing device which has a first roller, a second roller arranged so as to be contiguously opposed to the first roller and a third roller connected to the first roller through an endless belt and fixes a developer image on a transfer medium by passing the transfer medium on which the developer image has been transferred between the second roller and the endless belt, the first and second rollers being in contact with each other through the endless belt; a heating device which has a first heat source provided in the second roller and a second heat source provided in the third roller and heats the second roller and the endless belt by energizing the first and second heat sources in order to generate heat; a detection device which detects a temperature of the endless belt; and a control device which controls energization of the first and second heat sources based on a result of detection by the detection device in such a manner that the endless belt reaches a predetermined temperature.

According to a third aspect of the present invention, there is provided an image forming apparatus comprising: a rotatable image support which supports an electrostatic latent image; an image forming device which forms an electrostatic latent image to the image support; a developing device which supplies a developer to the electrostatic latent image formed by the image forming device in order to obtain a developer image; a transferring device which transfers the developer image developed by the developing device onto a medium; a fixing device which has a first roller and a second roller which is pressed against the first roller and fixes the developer image on a transfer medium by passing the transfer medium on which the developer image has been transferred between the first and second rollers; first and second heat sources which are respectively provided in the first and second rollers and heat the first and second rollers when energized to generate heat; a detection device which detects a temperature of the first roller; and a control device which controls energization of the first and second heat sources based on a result of detection by the detection device in such a manner that the first roller reaches a predetermined temperature.

According to a fourth aspect of the present invention, there is provided an image forming apparatus comprising: a rotatable image support which supports an electrostatic latent image; an image forming device which forms an electrostatic latent image to the image support; a developing device which supplies a developer to the electrostatic latent image formed by the image forming device in order to obtain a developer image; a transferring device which transfers the developer image developed by the developing device onto a medium; a fixing device which has a first roller, a second roller arranged so as to be contiguously opposed to the first roller and a third roller connected to the first roller through an endless belt and fixes the developer image on a transfer medium by passing the transfer medium on which the developer image has been transferred between the second roller and the endless belt, the first and second roller being in contact with each other through the endless belt; a heating device which has a first heat source provided in the second roller and a second heat source provided in the third roller and heats the second roller and the endless belt by energizing the first and second heat sources in order to generate heat; a detection device which detects a temperature of the endless belt; and a control device which controls energization of the first and second heat sources based on a result of detection by the detection device in such a manner that the endless belt reaches a predetermined temperature.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is an inner structural view showing a color electrophotographic copier according to a first embodiment of the present invention;

FIG. 2 is a structural view showing a fixing apparatus;

FIG. 3 is a block diagram showing a heating control system of fixing and pressure rollers;

FIG. 4 is a structural view showing another embodiment of a fixing apparatus; and

FIG. 5 is a block diagram showing a heating control system of the fixing and pressure rollers depicted in FIG. 4.

### DETAILED DESCRIPTION OF THE INVENTION

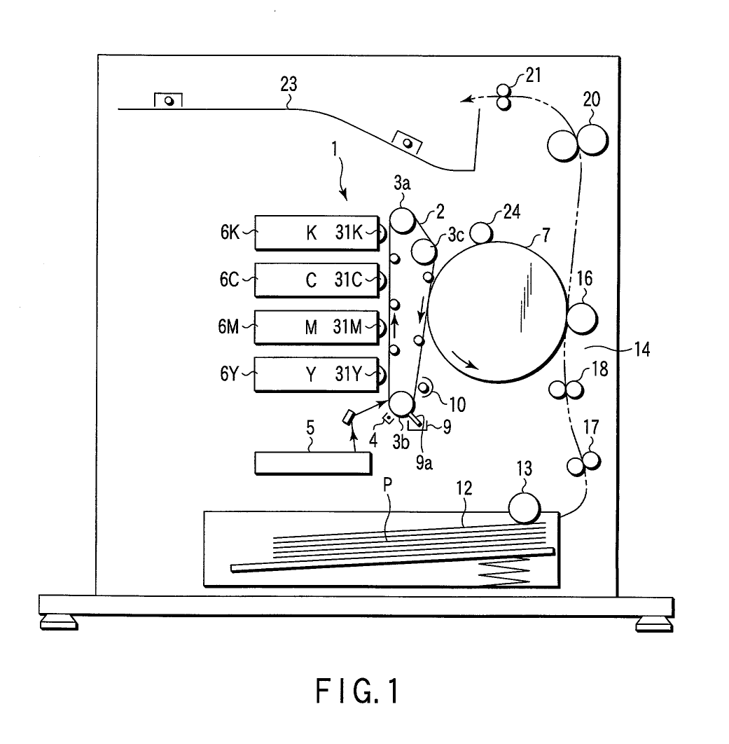

FIG. 1 is a structural view showing a color electrophotographic copier as an image forming apparatus according to an embodiment of the present invention.

This color electrophotographic copier includes an image forming portion 1. The image forming portion is provided with a photoreceptor belt 2 having the flexibility as an image support. This photoreceptor belt 2 is stretched between a plurality of first to third rollers 3a to 3c with predetermined tensile force and caused to travel in the direction indicated by an arrow.

To a peripheral part of the photoreceptor belt 2 are arranged a charger 4 which electrically charges the photoreceptor belt 2 to a predetermined potential along its traveling direction, a laser exposing deice 5 as an image forming device which forms an electrostatic latent image to the charged photoreceptor belt 2, and developing devices 6Y to 6K which supply toners of respective colors, i.e., yellow (Y), magenta (M), cyan (C) and black (K) as developers to the electrostatic latent image formed to the photoreceptor belt 2 in order to visualize this image.

Further, to the peripheral part of the photoreceptor belt 2 are provided an intermediate transfer drum 7 as a rotatable transferring device which temporarily holds toner images formed on the photoreceptor belt 2 along its traveling direction, a de-electrification lamp 10, and a cleaner device 9 which removes the toner remaining on the photoreceptor belt 2.

A part of the photoreceptor belt 2 which is stretched between the first and second rollers 3a and 3b is opposed to the developing devices 6Y to 6K with a fixed gap therebetween, and a part of the same which is stretched between the second and the third roller 3b and 3c is pressed against the outer peripheral surface of the intermediate transfer drum 7.

Incidentally, a drive motor (not shown) is connected to any one of the first to third rollers 3a to 3c, and the first to third rollers 3a to 3c are driven to rotate at a predetermined speed in the direction indicated by an arrow by rotation of the drive motor.

On the other hand, a paper cassette 12 which accommodates therein paper P as a medium in a predetermined size is provided to the lower part of the image forming portion 1. A paper feed roller 13 which takes out the sheets of paper P one by one is provided to the paper cassette 12. The paper P taken out by the paper feed roller 13 is carried upwards along a carriage path 14 extending in the vertical direction.

A pair of carriage rollers 17, a pair of aligning rollers 18, a transfer roller 16 as a transferring device, a fixing apparatus 20 and a pair of paper ejection rollers 21 are sequentially arranged in the carriage path 14 along the carriage direction of the paper P.

A pair of the carriage rollers 17 hold and carry the paper P, and the aligning rollers 18 temporarily stop the paper P being carried and correct the inclination of the paper P with respect to the carriage direction. Also, the aligning rollers 18 match an end of the paper P with an end of the toner image on the intermediate transfer drum 7. The transfer roller 16 is provided so as to be opposed to the intermediate transfer drum 7, and transfers a toner image formed on the intermediate transfer drum 7 onto the paper P. The fixing apparatus 20 fixes the toner image transferred onto the paper P. A pair of the paper ejection rollers 21 ejects the paper P, and a paper ejection tray 23 which receives the paper to be ejected is provided to the paper ejection side of a pair of the paper ejection rollers 21.

A full-color printing operation by the color electrophotographic copier mentioned above will now be described.

A surface of the photoreceptor belt 2 having a back side of a photosensitive layer being grounded at 0 V is uniformly charged to −700 V by the charger 4, and then the laser exposing device 5 is driven in accordance with a yellow image signal from a non-illustrated control portion, thereby forming a latent image of a yellow image on the photoreceptor belt 2. The potential of the electrostatic latent image is approximately −100 V.

On the other hand, before writing the latent image of the yellow image, the developing device 6Y of yellow is moved toward the photoreceptor belt 2. The developing roller 31Y is rotated simultaneously with this movement, and a voltage of −300 V is applied to the developing roller 31Y. When the developing roller 31Y is brought into contact with the photoreceptor belt 2 by movement of the developing device 6Y, the latent image is developed, and a toner image of yellow is formed on the photoreceptor belt 2.

The toner image of yellow on the photoreceptor belt 2 is electrostatically transferred onto the intermediate transfer drum 7 to which a voltage of +1 kV is applied, and the toner remaining on the photoreceptor belt 2 is subjected to de-electrification by the de-electrification lamp 10 and then removed by a blade 9a of the cleaner device 9. Thereafter, the surface of the photoreceptor belt 2 is again electrically charged, and a latent image of a magenta image is formed as similar to the above. This latent image is developed by the magenta developing device 6M to become a toner image of magenta and superposed on the toner image of yellow on the intermediate transfer drum 7. Subsequently, a similar cycle is repeated with respect to cyan (C) and black (K), thereby forming a color image having superposed toner images of four colors on the intermediate transfer drum 7.

On the other hand, at this moment, the paper P is fed from the paper feed cassette 12 by rotation of the paper feed roller 13, and the paper P is supplied along the carriage path 14. The paper P is held and carried by a pair of the carriage rollers 17 and supplied to a pair of the resist rollers 18. Here, the paper P is aligned and fed between the intermediate transfer drum 7 and the transfer roller 16. A voltage of +2 to 3 kV is applied to the transfer roller 16. As a result, the toner images of four colors formed on the intermediate transfer drum 7 are collectively transferred onto the paper P.

At the time of transfer, the toner remaining on the intermediate transfer drum 7 is removed by a cleaner device 24 using a brush to which a voltage of +1.5 kV is applied. The paper P to which the toner images of four colors are transferred is supplied to a heat roll type fixing apparatus 20. Here, the toner images are fused and fixed on the paper P, thus forming a color image. After fixing, the paper P is ejected onto the paper ejection tray 23 by a pair of the paper ejection rollers 21.

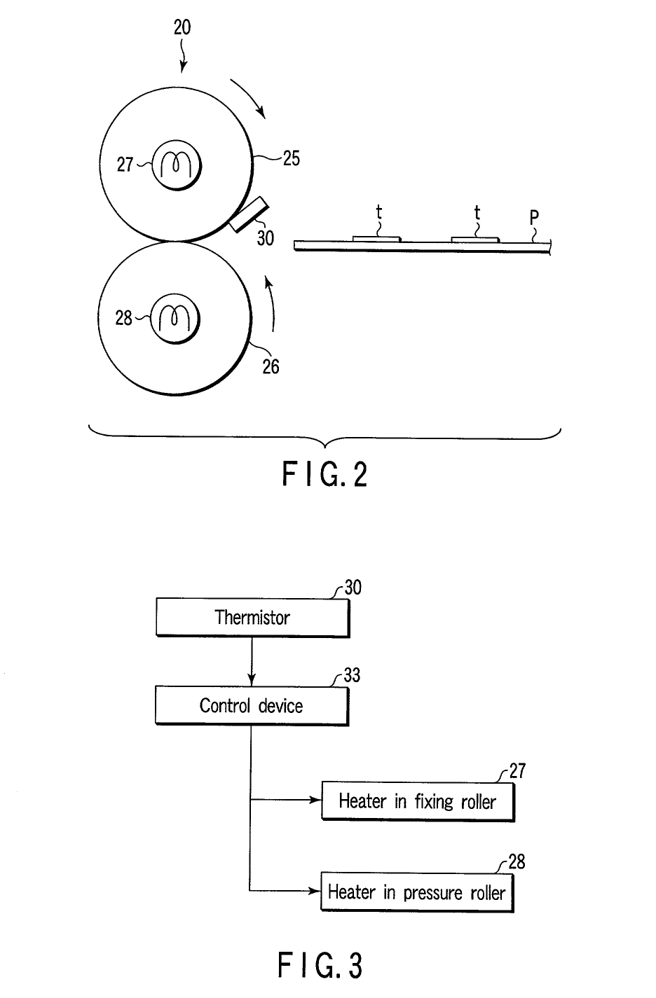

FIG. 2 is a structural view showing the fixing apparatus 20 mentioned above.

The fixing apparatus 20 is constituted by a fixing roller 25 as a first roller and a pressure roller 26 as a second roller which is pressed against the lower side of the fixing roller 25. A heater 27 as a first heat source is provided inside the fixing roller 25, and a heater 28 as a second heat source is provided inside the pressure roller 26.

The fixing and pressure rollers 25 and 26 are heated by heat generation of the heaters 27 and 28. The necessary temperature of the fixing roller 25 is determined as 170° C., and the necessary temperature of the pressure roller 26 is determined as 120° C. A thermistor 30 as a detection device is provided in the vicinity of the fixing roller 25, and the thermistor 30 detects a temperature of the fixing roller 25.

FIG. 3 is a block diagram showing a heating control system of the fixing roller 25 and the pressure roller 26.

The thermistor 30 is connected to a control device 33 through a signal circuit, and the heater 27 of the fixing roller 25 and the heater 28 of the pressure roller 26 are connected to the control device 33 through the control circuit.

Temperature information of the fixing roller 25 detected by the thermistor 30 is supplied to controlling means 33 through the signal circuit. When the fixing roller 25 reaches a predetermined temperature (170° C.), energization of the heater 27 in the fixing roller 25 and the heater 28 in the pressure roller 26 is stopped by the controlling means 33.

That is, control over energization of the heater 27 in the fixing roller 25 and the heater 28 in the pressure roller 26 is carried out based on only a temperature of the fixing roller 25, and energization in the heater 4 inside the pressure roller 2 continues even after the pressure roller 2 reaches a predetermined temperature, i.e., 120° C.

The fixing operation will now be described.

When the power supply is turned on, the heaters 27 and 28 of the fixing roller 25 and the pressure roller 26 respectively generate heat, and the fixing roller 25 and the pressure roller 26 are heated. As a result of heating, temperatures of the fixing roller 25 and the pressure roller 26 increase, and the temperature of the fixing roller 25 is detected by the thermistor 30. The detected temperature is supplied to the controlling means through the signal circuit. When the detected temperature reaches a predetermined temperature (170° C.), the controlling means stops energization of the heaters 27 and 28. That is, energization of the heater 28 in the pressure roller 26 continues even after the pressure roller 26 reaches the necessary temperature, i.e., 120° C., and heating carries over.

When the fixing roller 25 reaches a predetermined temperature (170° C.), the paper P onto which a toner image t has been transferred is supplied and passes between the fixing roller 25 and the pressure roller 26. As a result, the toner image t is heated and the pressure is applied to this image. The toner image t is consequently fused and fixed on the paper P.

As described above, when the power supply is turned on, the fixing apparatus 20 starts the warm-up operation. However, the heater 28 in the pressure roller 26 continues heating even after the pressure roller 26 reaches 120° C. which is the necessary temperature. Therefore, heat of the fixing roller 25 is not taken by the pressure roller 26, and the time till the fixing roller 25 reaches 170° C. as the necessary temperature can be shortened.

Furthermore, when the fixing apparatus 20 enters the ready state and the paper P passes between the fixing and pressure rollers 25 and 06, the temperatures of the fixing and pressure rollers 25 and 26 drop. At this moment, the heaters 27 and 28 of the fixing roller 25 and the pressure roller 26 are again energized, and the fixing roller 25 and the pressure roller 26 are heated. In such a case, as similar to the above, since the heater 28 of the pressure roller 26 continues heating even after the pressure roller 26 reaches the necessary temperature (120° C.), the time till the fixing roller 25 reaches the necessary temperature (170° C.) can be shortened. Thus, when the paper P is continuously fed between the fixing and pressure rollers 25 and 26, fixing is enabled while narrowing the distance between sheets of paper.

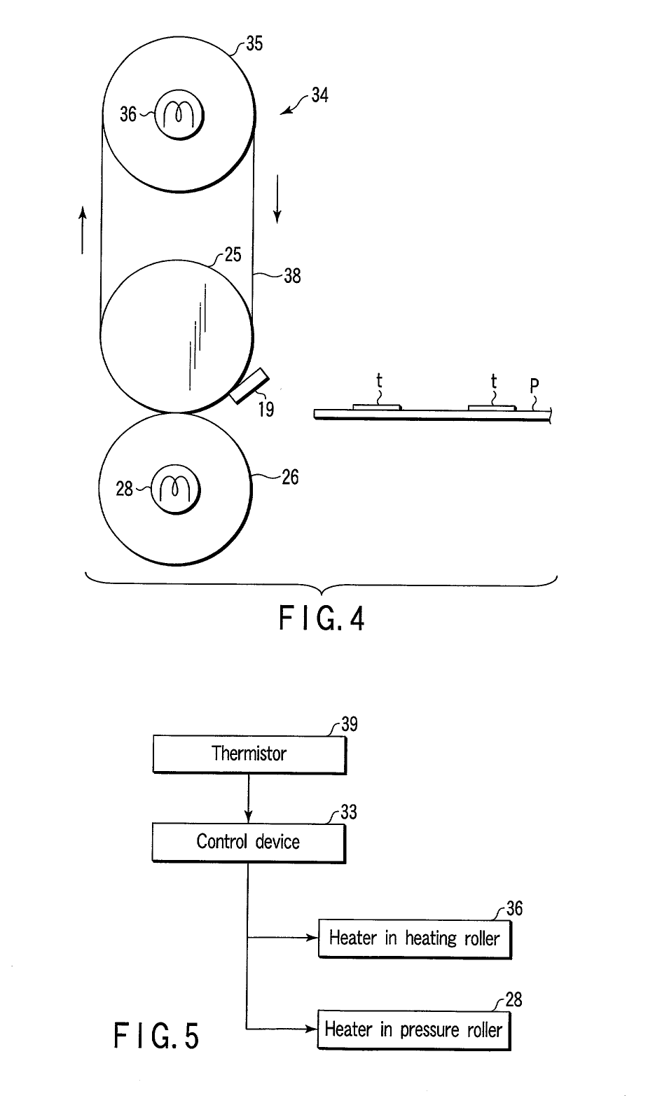

FIG. 4 shows a fixing apparatus 34 according to a second embodiment of the present invention.

It is to be noted that like reference numerals denote parts similar to those described in connection with the first embodiment, thereby omitting their explanation.

In this second embodiment, the heater is not provided inside the fixing roller 25. A heating roller 35 as a third roller is provided to the upper part of the fixing roller 25, and a heater 36 as a second heat source is provided inside the heating roller 35. A heat transfer belt 38 as an endless belt is stretched between the fixing roller 25 and the heating roller 35. A thermistor 39 as a detection device which detects a temperature of the heat transfer belt 38 is provided in the vicinity of a part of the heat transfer belt 38 stretched to the fixing roller 25.

FIG. 5 is a block diagram showing a heating control system of the heaters 36 and 28 of the heating roller 35 and the pressure roller 26.

The thermistor 39 is connected to the control device 33 through a signal circuit, and the heater 36 of the heating roller 35 and the heater 28 of the pressure roller 26 are connected to the control device 33 through the control circuit.

Temperature information of the heat transfer belt 38 detected by the thermistor 39 is supplied to the control device 33 through the signal circuit. When the heat transfer belt 38 reaches a predetermined temperature (170° C.), the control device 33 stops energization of the heater 36 in the heating roller 35 and the heater 28 in the pressure roller 26.

That is, control over energization of the heater 36 in the heater roller 35 and the heater 28 in the pressure roller 26 is carried out based on only the temperature of the heat transfer belt 38, and energization of the heater 28 in the pressure roller 2 continues even after the pressure roller 26 reaches a predetermined temperature, i.e., 120° C.

The fixing operation will now be described.

When the power supply is turned on, the heaters 36 and 28 of the heating roller 35 and the pressure roller 26 respectively generate heat, and the heat transfer belt 38 and the pressure roller 26 are heated. As a result of heating, temperatures of the heat transfer belt 38 and the pressure roller 26 increase, and the temperature of the heat transfer belt 38 is detected by the thermistor 39. This detected temperature is supplied to the control device 33 through the signal circuit. Energization of the heater 36 in the heating roller 35 continues even after the pressure roller 26 reaches 120° C. which is the necessary temperature, and heating carries on.

Then, when the heat transfer belt 38 reaches a predetermined temperature (170° C.), the control device 33 stops energization of the heaters 36 and 28. Thereafter, when the paper P on which the toner image t has been transferred is fed and passes between the heat transfer belt 38 stretched to the fixing roller 25 and the pressure roller 26, the toner image t is heated and subjected to pressure application, thereby being fused and fixed on the paper P.

As described above, when the power supply is turned on, the fixing apparatus 34 starts the warm-up operation. However, even after the pressure roller 26 reaches 120° C. which is the necessary temperature, the heater 28 in the pressure roller 26 is caused to generate heat until the heat transfer belt 38 reaches 170° C. Therefore, heat of the heat transfer belt 38 is not taken by the pressure roller 26, and the time till the heat transfer belt 38 reaches 170° C. as the necessary temperature can be shortened.

Moreover, when the fixing apparatus 34 enters the ready state and the paper P passes between the heat transfer belt 38 and the pressure roller 26, temperatures of the heat transfer belt 38 and the pressure roller 26 drop. At this moment, the heaters 36 and 28 of the heat transfer belt 38 and the pressure roller 26 are again energized, and the heat transfer belt 38 and the pressure roller 26 are again heated.

In such a case, as similar to the above, even after the pressure roller 26 reaches the necessary temperature, the heater 28 of the pressure roller 26 continues heating till the heat transfer belt 38 reaches 170° C. Therefore, the time required for the heat transfer belt 38 to reach the necessary temperature can be shortened. Accordingly, in case of continuously feeding the paper P between the heat transfer belt 38 and the pressure roller 26, fixing is enabled while narrowing the distance between sheets of paper.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fixing apparatus comprising:
a fixing device which has a first roller and a second roller pressed against said first roller and fixes a developer image on a transfer medium by passing said transfer medium on which said developer image has been transferred between said first and second rollers;
first and second heat sources which are respectively provided inside said first and second rollers, and generate heat when energized in order to heat said first and second rollers;
a detection device which detects a temperature of said first roller; and
a control device which controls energization of said first and second heat sources based on a result of detection of said detection device in such a manner that said first roller reaches a predetermine temperature.

2. A fixing apparatus according to claim 1, wherein said detection device is a thermistor.

3. A fixing apparatus according to claim 1, wherein said predetermined temperature is 170° C.

4. A fixing apparatus comprising:
a fixing device which has a first roller, a second roller arranged so as to be contiguously opposed to said first roller and a third roller connected to said first roller through an endless belt, and fixes a developer image on a transfer medium by passing said transfer medium on which said developer image has been transferred between said second roller and said endless belt, said first and second rollers being in contact with each other through said endless belt;
a heating device which has a first heat source provided in said second roller and a second heat source provided in said third roller, and heats said second roller and said endless belt by energizing said first and second heat sources in order to generate heat;
a detection device which detects a temperature of said endless belt; and
a control device which controls energization of said first and second heat sources based on a result of detection of said detection device in such a manner that said endless belt reaches a predetermined temperature.

5. A fixing apparatus according to claim 4, wherein said detection device is a thermistor.

6. A fixing apparatus according to claim 4, wherein said predetermined temperature is 170° C.

7. An image forming apparatus comprising:
a rotatable image support which supports an electrostatic latent image;
an image forming device which forms an electrostatic latent image to said image support;
a developing device which supplies a developer to said electrostatic latent image formed by said image forming device in order to obtain a developer image;
a transferring device which transfers said developer image developed by said image developing device onto a medium;
a fixing device which has a first roller and a second roller pressed against said first roller, and fixes said developer image on a transfer medium by passing said transfer medium on which said developer image has been transferred between said first and second rollers;
first and second heat sources which are respectively provided in said first and second rollers and generate heat in order to heat said first and second rollers when energized;
a detection device which detects a temperature of said first roller; and
a control device which controls energization of said first and second heat sources based on a result of detection of said detection device in such a manner that said first roller reaches a predetermined temperature.

8. An image forming apparatus comprising:
a rotatable image support which supports an electrostatic latent image;
an image forming device which forms an electrostatic latent image to said image support;
a developing device which supplies a developer to said electrostatic latent image formed by said image forming device in order to obtain a developer image;
a transferring device which transfers said developer image developed by said image developing device onto a medium;
a fixing device which has a first roller, a second roller arranged so as to be contiguously opposed to said first roller and a third roller connected to said first roller through an endless belt, and fixes said developer image on a transfer medium by passing said transfer medium on which said developer image has been transferred between said second roller and said endless belt, said first and second rollers being in contact with each other through said endless belt;
a heating device which has a first heat source provided in said second roller and a second heat source provided in said third roller, and heats said second roller and said endless belt by energizing said first and second heat sources to generate heat;
a detection device which detects a temperature of said endless belt; and
a control device which controls energization of said first and second heat sources based on a result of detection of said detection device in such a manner that said endless belt reaches a predetermined temperature.
